(19) United States
(12) Patent Application Publication
(10) Pub. No.: US 2017/0059198 A1
(43) Pub. Date: Mar. 2, 2017

(54) METHOD AND APPARATUS FOR RETROFITTING AN AIR CONDITIONER TO SMART OPERATION

(71) Applicant: SENSIBO LTD., Tel Aviv (IL)

(72) Inventors: Ran ROTH, Tel Aviv (IL); Omer ENBAR, Tel Aviv (IL)

(21) Appl. No.: 15/096,690

(22) Filed: Apr. 12, 2016

Related U.S. Application Data
(60) Provisional application No. 62/210,084, filed on Aug. 26, 2015.

(51) Int. Cl. F24F 11/00; G06F 3/02; G05B 15/02; G06F 3/14

(52) U.S. Cl. CPC F24F 11/0086; G06F 3/14; G06F 3/0202; G05B 15/02; F24F 2011/0091

(57) ABSTRACT

Method and apparatus for retrofitting an existing A/C to extend functionality thereof. One apparatus configured to be connected in between a UI board and a controller of the A/C, wherein the apparatus comprising a monitoring module configured to monitor signals transmitted from one component of the A/C to another component of the A/C, whereby content of the signal is extractable by the apparatus. Another apparatus configured to be connected in between a UI board and a controller of the A/C, comprising a signal generation module for generating signals to a component mimicking signals generated by another component of the A/C, whereby the A/C controller and/or UI board may be extend to provide additional functionality.

### CROSS-REFERENCE TO RELATED APPLICATION

This application claims the benefit of U.S. Provisional Application No. 62/210,084 filed Aug. 26, 2015, entitled “A system retrofitting existing air conditioners that enables monitoring and/or controlling the unit by a secondary system and/or cloud service”, which is hereby incorporated by reference in its entirety.

### TECHNICAL FIELD

The present disclosure relates to the operating of air conditioners in general, and to retrofitting an existing air conditioning (A/C) unit for monitoring and control by a computerized system, in particular.

### BACKGROUND

Legacy air-conditioning (A/C) units, such as split, mini-split, floor standing, portable, window mounted, or likewise arrangements such as employed for regulating temperature in residential rooms, office spaces and similar habitats, are typically provided as stand-alone devices with a limited, fixed set of basic functionalities. Such units are often operated by a remote control, using Infrared (IR) signals or the like, or by a set of buttons disposed on a control panel or on the device itself. In some instances, the operating of an A/C unit is further controlled by sensors coupled to it, such as presence sensors or the like. A control part usually included within the A/C unit is responsible for communicating commands from the user to the A/C unit, such as by sensing commands of a remote control using an IR receiver. In addition, these units usually have a display part which communicates information about the A/C unit to a user, such as: target temperature; fan speed; operation mode, e.g. cooling, heating, fan, dry, clean, or the like; error codes in case of malfunction; or the like. In most A/C units, the display and control parts are located on a board separated from the main board of the A/C unit which controls its operation.

### BRIEF SUMMARY

One exemplary embodiment of the disclosed subject matter is an apparatus configured to be connected to an air conditioner, wherein the air conditioner comprising a user interface (UI) board and a controller, wherein the UI board comprising a user interface for providing user commands, wherein the UI board and the controller are connected to one another via a wired communication channel, wherein a component of the air conditioner is configured to transmit signals to another component of the air conditioner via the wired communication channel; wherein said apparatus being connected to the wired communication channel in between the UI Board and the controller; wherein said apparatus comprising a monitoring module configured to monitor signals transmitted from the component of the air conditioner to the other component of the air conditioner, whereby content of the signal is extractable by the apparatus.

Another exemplary embodiment of the disclosed subject matter is an apparatus configured to be connected to an air conditioner, wherein the air conditioner comprising a user interface (UI) board and a controller, wherein the UI board comprising a user interface for providing user commands, wherein the UI board and the controller are connected to one another via a wired communication channel, wherein the UI board is configured to transmit signals to the controller indicating the user commands; wherein said apparatus being connected to the wired communication channel in between the UI Board and the controller; wherein said apparatus comprising a signal generation module for generating signals to a component of the air conditioner mimicking signals generated by another component of the air conditioner.

Yet another exemplary embodiment of the disclosed subject matter is a method comprising: monitoring signals transmitted from a component of an air conditioner to another component of the air conditioner, wherein the air conditioner comprises components that comprise a user interface (UI) board and a controller, wherein the UI board comprising a user interface for providing user commands, wherein the UI board and the controller are connected to one another via a wired communication channel, wherein said monitoring is performed using a Man In The Middle (MITM) device physically connected to the wired communication channel in between the component and the other component.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A and 1B show schematic illustrations of environments in which the disclosed subject matter is used, in accordance with some exemplary embodiments of the disclosed subject matter;

FIGS. 2A-2E show flowchart diagrams of methods, in accordance with some exemplary embodiments of the disclosed subject matter; and

FIG. 3 is a block diagram of an apparatus, in accordance with some exemplary embodiments of the disclosed subject matter.

### DETAILED DESCRIPTION

In recent years there is an ever-growing trend of extending internet connectivity beyond traditional networked devices, such as computers and cellular telephones, to a wide range of physical objects including everyday consumer electronic products and home appliances, such as, for example, television sets, refrigerators, vacuum cleaners, cooking ovens, or the like. The network of these objects and the communication that occurs between them and other Internet-enabled devices and systems are commonly referred to as the Internet of Things (IoT).

Some manufacturers offer support of IoT capabilities in certain recent models of A/C units, usually provided via a USB dongle or a similar device configured to be plugged into a dedicated socket integrated in the unit, or by an Original Equipment Manufacturer (OEM) part embedded in the main circuit board. However, there is a need to connect legacy A/C units to the Internet. The A/C units of this sort are typically not equipped with high and advanced capabilities, let alone with network connectivity, to allow for more complex and/or remote interaction of a user with the A/C unit via an existing communication channel, such as the Internet.

One technical problem dealt with by the disclosed subject matter is to enhance functionality of an air conditioner. In some exemplary embodiments, it may be desired to automatically and dynamically track a state of an air conditioner.

Another technical problem dealt with by the disclosed subject matter is to extend a user interface (UI) of an air-conditioning (A/C) unit with additional functionality not originally supported by the manufacturer's specification.

Yet another technical problem dealt with by the disclosed subject matter is to retrofit a legacy A/C unit to remote monitoring and control via a network connection.

In the context of the present disclosure, the term “UI board” refers to a component of an A/C unit which contains either a control component for communicating commands from a user to the A/C unit, a display component for communicating information on a state of the A/C unit to a user, or both. It may be appreciated that in some A/C units there may not be a display component present, and that in others there may not be a separate control component provided. Additionally or alternatively, each of these components may be broken down to any number of physical circuit boards. For convenience and clarity purposes and without loss of generality or narrowing of the claimed scope, all such components are collectively referred to as the UI board throughout the present disclosure.

In the context of the present disclosure, the term “controller” refers to a main board of an A/C unit or any similar component responsible for the operation of the A/C unit. The controller may be configured to receive inputs from the UI board, process such inputs and operate the A/C unit accordingly. The controller may be configured to output signals to the UI board to be provided to the user, such as via a display, using a speaker, or the like.

One technical solution is to employ a “man in the middle” approach taking advantage of existing communication lines from the UI board to the controller and from the controller to the UI board. Signals transmitted from the UI board to the controller conveying user commands to the A/C unit may be intercepted and monitored. Based on the monitored signals, for example, a state of the A/C unit can be tracked. The monitoring and tracking may employ intercepting of signals transmitted from the controller to the UI board defining an output indicative of the state of the A/C unit to be provided to a user via an output device coupled to the UI board.

In some exemplary embodiments, the UI board may comprise an Infrared (IR) receiver, such that the UI board transmits a signal to the controller in response to the IR receiver receiving an IR signal, e.g. from an IR based remote control supplied with the A/C unit and configured for operating it. Additionally or alternatively, the UI board may comprise one or more buttons, such as knobs to be pressed or turned, dials to spin, switches to flip, or the like, wherein the UI board transmits a signal to the controller responsive to one of the buttons being engaged. As another example, the UI board may comprise Analog potentiometer, such as for setting the temperature, and the signal generated thereby may be conveyed to the controller. As yet another example, the UI board may comprise sensors, such as temperature sensors, presence sensors, or the like, the output of which—raw or processed—may be conveyed to the controller. As yet another example, some of the signals may be provided in digital form, such as using digital wire protocols, such as Universal Asynchronous Receiver/Transmitter (UART), Serial Peripheral Interface (SPI), Inter-Integrated Circuit (I2C), or the like. The signals may be provided after being processed, such as by a chip embedded in the UI board.

In some exemplary embodiments, the UI board may comprise a display device for displaying a state of the A/C unit, such that the display on the display device is settable by signals transmitted from the controller to the UI board. In some further exemplary embodiments, the controller may be configured for sending error codes to be displayed via the display device, whereby indicating an error state or malfunction of the A/C unit. The controller may identify an error autonomously and without connection to a user input provided thereto. Additionally or alternatively, an error may be identified upon attempting to implement a command provided to the controller via the UI board.

In some exemplary embodiments, monitoring of input signals transmitted from the UI board to the controller, and of output signals transmitted from the controller to the UI board in response to the received input signals, may be performed. The monitored input and respective output signals may be processed to automatically and dynamically determine a mapping between input signals and target states of the A/C unit set by the controller.

In some exemplary embodiments, the monitored signals may be processed by a local device physically connected to the A/C unit, e.g. installed within it or in the vicinity thereof. Additionally or alternatively, the monitored signals or data extracted therefrom may be sent to a remote server for processing and/or storage.

In some exemplary embodiments, monitoring of the output signals transmitted responsive to input signals received may be performed in order to verify proper execution of a conveyed user command to the A/C unit by the controller.

Another technical solution is to use a “man in the middle” mechanism, similarly as described above, for actively intervening in the communications exchanged between the UI board and the controller, by selectively blocking a transmitted signal or generating a mimicked signal for interjecting commands to the A/C unit and/or outputs to its output device. Specifically, by generating signals mimicking input signals from the UI board to the controller, switching of the A/C unit to a desired target state may be effected. Similarly, signals mimicking output signals from the controller to the UI board may be generated to effect provision of a certain desired output to a user. Thus, in this manner, the regular user interface of the A/C unit may be either circumvented or extended with additional functionality not supported by the controller.

In some exemplary embodiments, generation of signals mimicking input or output signals may be performed in response to a command received via a communication channel, such as, for example, the Internet, whereby operation of the A/C unit and/or an output device thereof may be controlled by a source external to the A/C unit and its user interface, e.g. from a remote location.

Additionally or alternatively, the signals may be generated in response to a predetermined pattern of user commands being detected in a series of input signals transmitted by the UI board, wherein the predetermined pattern corresponds to an enhanced functionality command encoded thereby. The predetermined pattern may be either defined by a user in a custom setting or programmed in advance as part of a default setting. In some exemplary embodiments, default definitions of enhanced functionality command may be re-programmed by a user or a service provider, whereby a specific mapping between a pattern of user commands and an enhanced functionality command may be added, deleted or modified.

In some exemplary embodiments, the monitoring of communication signals from the UI board to the controller and/or vice versa may be performed by a local device deployed in the physical whereabouts of the A/C unit. The local device may be configured to physically connect to communication lines going out of and/or into the UI board and the controller. In some exemplary embodiments, the local device may be configured to connect to a power line of the A/C unit, such as a power line going into or out of the controller. Additionally or alternatively, the local device may comprise an autonomous energy supply source, such as batteries, solar panels, or the like.

In some exemplary embodiments, the local device may comprise a communication module for transmitting and receiving data via a communication network. The communication module may comprise a radio frequency (RF) transceiver for wireless communication, such as Wi-Fi, WiMax, LTE, Bluetooth™, or the like. The communication module may be used to relay information on monitored signals from the local device to a remote server, whereby a state of the A/C unit may be tracked by the remote server based on the monitored signals.

In some exemplary embodiments, the communication module may be utilized for transferring user commands to the A/C unit from an external source not comprised in the user interface of the A/C unit. The local device may generate corresponding input signals to cause the controller to execute user commands received via the communication module. In some exemplary embodiments, the local device may be coupled with an application program being executed on a computing device, such as a desktop, laptop, handheld or tablet computer, a smartphone, a personal digital assistant (PDA), or the like, whereby user interaction with the local device may be enabled.

As an illustrative example, consider a use case of the disclosed subject matter in which a user provides a command to change the target temperature of the A/C unit, using an application program executed by a user device, such as a mobile phone or laptop, coupled with the local device via a communication channel such as, for example, the Internet. The local device may generate a signal mimicking a respective input signal transmitted by the UI board for indicating the command to the controller, whereby causing the controller to change the target temperature accordingly. The controller may transmit an output signal to the UI board indicating the new temperature to be outputted, e.g., by being displayed on a display device of the A/C unit. The output signal may be monitored by the local device to validate successful performance of the command. In some exemplary embodiments, the local device may further transmit a communication back to the application program, such as an acknowledgement message, a success/fail status of the command, or the like, whereby feedback to a user of the application program may be provided.

As another illustrative example, consider a use case of the disclosed subject matter in which a user uses it to operate an A/C unit in conjunction with a regular control means thereof, such as, for example, a remote control. In an exemplary scenario, the user may use the remote control to turn the A/C unit on, whereby causing the UI board to transmit a respective signal to the controller. The signal may be monitored by the local device, which may transmit a communication to the application program informative of the new state of the A/C unit, i.e. of it being turned on. In some exemplary embodiments, the signal itself may set the A/C state, such as indicating mode (e.g., Heat/Cool/Fan), fan speed and target temperature. In such a case, the state of the A/C may be extracted from the signal. Additionally or alternatively, the state of the A/C unit may be tracked by the local device and/or a remote server and updated accordingly responsive to the monitored signal.

As yet another illustrative example, consider a use case of the disclosed subject matter in which a user of a computing device executing the application program decides to temporarily disable usage of the remote control. The user may provide a blocking command via the application program, causing the local device to block signals transmitted from the UI board to the controller, such as, for example, by intercepting such signals and avoiding retransmission thereof to the controller. Additionally or alternatively, blocking of the signal may be implemented by adding noise thereto, thereby rendering the signal itself unusable by the receiving component. As a result, the use of the remote control may be effectively disabled. In some exemplary embodiments, the local device may monitor the signals and send to the application program a communication informative of the usage of the remote control. The application program may perform further actions in response to the communication, such as, for example, alerting the user that the remote control is being used, prompting the user for permission to execute a command provided using the remote control, or the like. Additionally or alternatively, selective blocking of user input may be applied by intercepting each input signal issued by the UI board, analyzing the content of the signal and determining whether or not to block the signal.

As yet another illustrative example, consider a use case of the disclosed subject matter in which the controller may be configured to send an error code indicating an error state or malfunction of the A/C unit to be displayed via a display device thereof. The local device may monitor a signal transmitted by the controller comprising an error code and respond accordingly. For example, the local device may transmit a communication informative of the error state or malfunction to either one of the application program, a support site of a manufacturer or service provider, an analytics database, or the like.

As yet another illustrative example, consider a use case of the disclosed subject matter in which the A/C is shut down due to power outage. Upon the electrical power being regained, the A/C may return automatically turn on and set to its previous state. In such a case, the state of the A/C cannot be ascertained from a current input signal. In some cases, the state may be automatically ascertained from an output signal sent from the controller to the UI board, such as setting a display or other output device.

As yet another illustrative example, consider a use case of the disclosed subject matter in which a certain function is not supported by the controller, such as, for example, a timer function for turning the A/C unit on or off at a specified time. A user may provide an enhanced functionality command for performing the desired operation, e.g., “SET TIMER OFF 22:30”, ordering to turn off the A/C unit on ten thirty PM. The enhanced functionality command may be provided either through the application program or by inputting a predetermined sequence of regular commands, such as, for example, a “+” command followed by a “−” command and another “+” command, where “+” and “−” are commands to raise or lower respectively the target temperature by one degree. In response to receiving the timer command, an appropriate processing action may be taken such as setting a counter or scheduling an event to the target time. The action may be performed either by the local device, the application program, or a remote server in communication with any one or both of them. Once the counter or the respective system clock reaches their target, a signal mimicking a turning off signal transmitted from the UI board to the controller may be generated by the local device, thereby effecting execution of the enhanced functionality command for setting an off timer.

As yet another illustrative example, consider a use case of the disclosed subject matter in which a certain functionality is not supported by the controller, such as, for example, a timer function for turning the A/C unit on or off at a specified time. After the timer function is enabled, either via the application program or via a pattern of commands obtained by the UI board, an output to the user may be provided. The content of the output may be determined either by the local device, the application program, or a remote server in communication with any one or both of them. After a determination is made, for example to set an LCD display to state “TIMER ON”, the local device may transmit a signal to the UI board mimicking a signal from the controller setting the display text on the LCD screen. In some exemplary embodiments, after a certain time elapsed, for example, ten seconds, the original LCD display may be restored by transmitting a second signal to the UI board.

As yet another illustrative example, consider a use case of the disclosed subject matter in which the A/C comprises an LCD display, which the user may turn on or off. Turning off the LCD display may reduce information available in the Man in the Middle (MITM) scheme. In some cases, a “turn off” command may be blocked from reaching the controller. Instead, the device being positioned on the communication channel in between the UI board and the controller, may be set to block all output signals from the controller to the LCD display, until such time as a “turn on” command is received. Additionally or alternatively, the device may allow the “turn off” command to be provided to the controller. However, when information is desired to be extracted from the display, the device may generate a “turn on” command, receive the output signal directed at the LCD display and generate a “turn off” command thereafter.

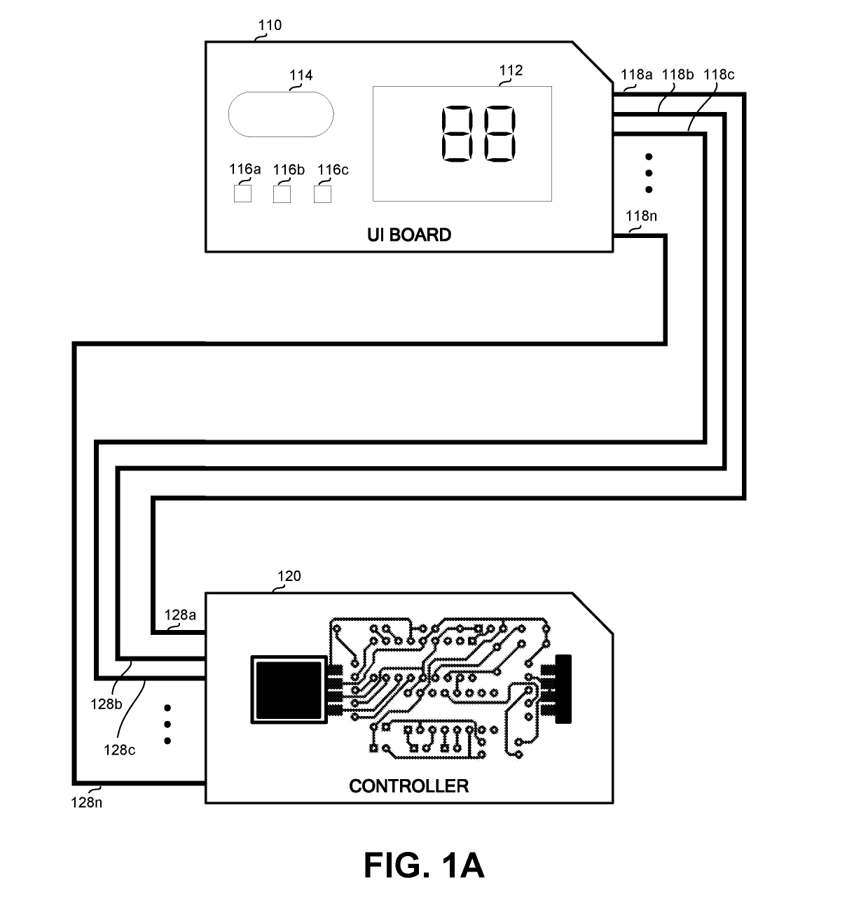

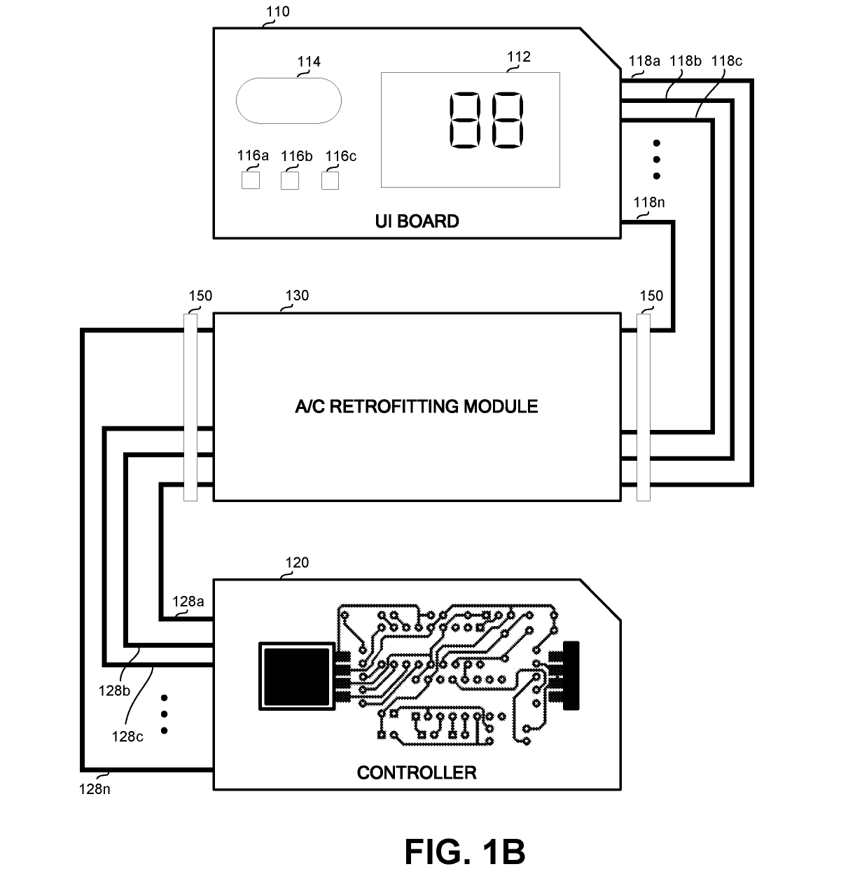

Referring now to FIGS. 1A and 1B, showing schematic illustrations of environments in which the disclosed subject matter is used, in accordance with some exemplary embodiments of the disclosed subject matter.

An air-conditioning (A/C) unit may comprise a User Interface (UI) Board 110 comprising a user interface for providing user commands, and a Controller 120 for controlling the A/C unit in accordance with the user commands provided via the user interface. UI Board 110 may comprise an output device, such as Display 112, for providing a user of the A/C unit output indicative of its state, a speaker (not shown) for providing audio cues to the user, or the like. In some exemplary embodiments, UI Board 110 may comprise an Infrared (IR) Receiver 114, configured for receiving IR signals indicating user commands provided via a remote control supplied with the A/C unit. Additionally or alternatively, UI Board 110 may comprise one or more buttons, such as Button 116a, Button 116b and Button 116c, used for providing user commands by means of engagement therewith, e.g., pressing, turning, flipping, or the like.

In some exemplary embodiments, UI Board 110 may comprise one or more wired connection lines, such as Line 118a, Line 118b, Line 118c, and so forth, up to Line 118n. Similarly, Controller 120 may comprise one or more wired connection lines, such as Lines 128a, 128b, 128c, and so forth up to 128n. Lines 118a through 118n and 128a through 128n may be configured to connect UI Board 110 and Controller 120 to one another, as is depicted in FIG. 1A. For example, Line 118a may be configured to connect to Line 128a, Line 118b may be configured to connect to Line 128b, and so forth. In some exemplary embodiments, Lines 118a through 118n and 128a through 128n may be the same lines, i.e. each connected pair such as Lines 118a and 128a, Lines 118b and 128b, and so forth, may be comprised by a single, continuous wired line. Lines 118a through 118n and 128a through 128n may comprise power supply lines, such as Vcc (positive supply voltage), GND (ground or negative supply), or the like. Additionally or alternatively, Lines 118a through 118n and 128a to 128n may comprise data communication lines, such as lines transferring signals emitted from IR Receiver 114 in response to receiving IR signals from the remote control, lines transferring signals emitted from Buttons 116a, 116b, 116c in response to being engaged, or the like. In some exemplary embodiments, such data communication lines may further comprise lines transferring signals transmitted to an output device of the A/C unit, such as, for example, a display device, used for indicating a state of the A/C unit to a user.

Referring now to FIG. 1B. In some exemplary embodiments, an Air Conditioner (A/C) Retrofitting Module 130 may be configured to physically connect to UI Board 110 via Lines 118a-118n and to Controller 120 via Lines 128a-128n. The connection of A/C Retrofitting Module 130 to UI Board 110 may replace or bypass former connection of UI Board 110 to Controller 120 via Lines 118a-118n. Similarly, the connection of A/C Retrofitting Module 130 to Controller 120 may replace or bypass former connection of Controller 120 to UI Board 110 via Lines 128a-128n. A/C Retrofitting Module 130 may be configured to intercept signals transmitted between UI Board 110 and Controller 120, either in any one of the directions or both. In some exemplary embodiments, A/C Retrofitting Module 130 may be further configured to selectively block transmitted signals and/or interject signals mimicking signals transmitted from UI Board 110 to Controller 120 or vice versa.

In some exemplary embodiments, a Connector Adapter 150 may be employed to logically and/or physically adapt Lines 118a-118n and/or Lines 128a-128n to connect to A/C Retrofitting Module 130. Connector Adapter 150 may comprise a standard General-Purpose Input/Output (GPIO) pin, programmable by A/C Retrofitting Module 130. Additionally or alternatively, Connector Adapter 150 may comprise a physical connector adapter configured to connect a first pin type to a second pin type, whereby adapting between transmitted signals and expected input/output of A/C Retrofitting Module 130. In some exemplary embodiments, A/C Retrofitting Module 130 may be a device useful for A/Cs of different models and by different vendors. As different models of A/Cs may utilize different interfaces between their UI Board 110 and Controller 120, such that different pins may serve for different purposes, adapters may be used to provide for a standardized, relatively easy to use, adaptation of the interface of the specific model to the general interface utilized by A/C Retrofitting Module 130.

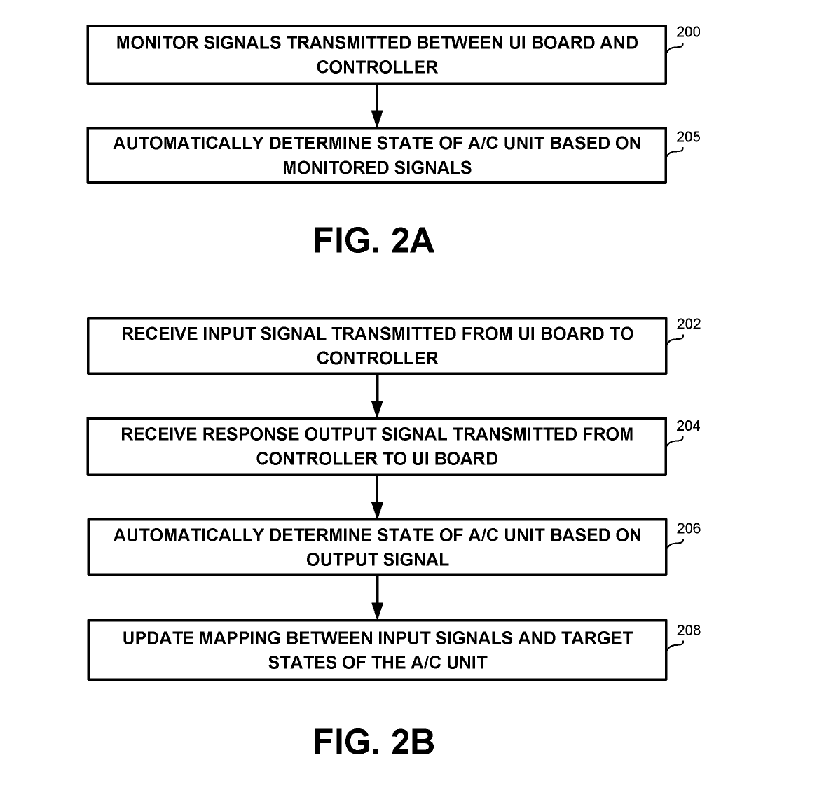

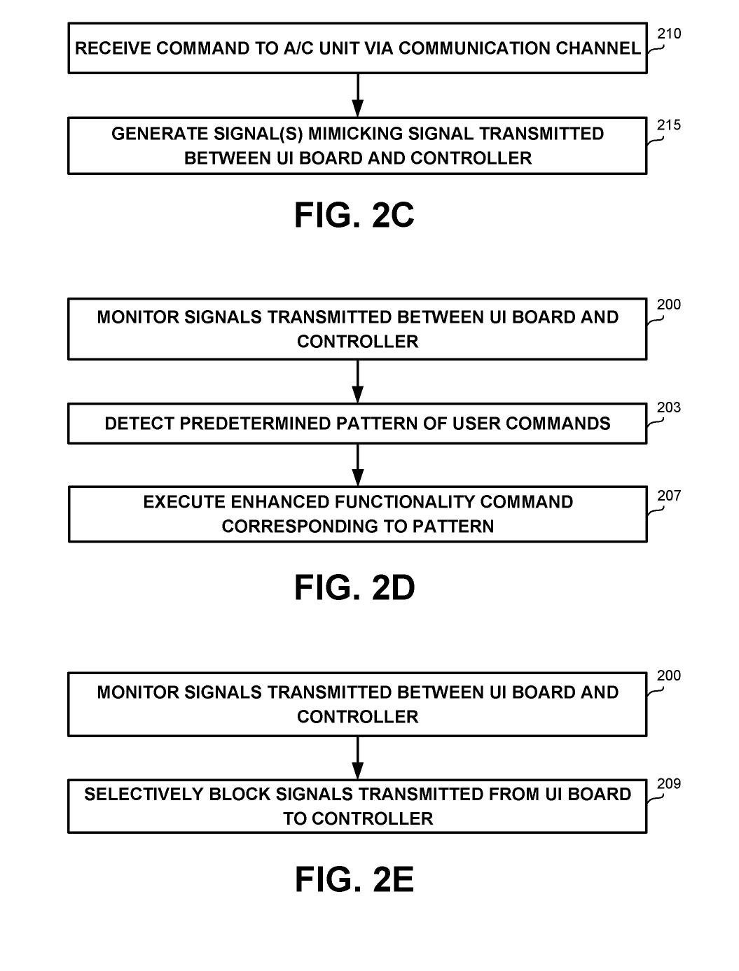

Referring now to FIG. 2A, showing a flowchart diagram of a method, in accordance with some embodiments of the disclosed subject matter.

On Step 200, monitoring of signals transmitted between a user interface (UI) board and a controller of an air conditioner (A/C) unit, may be performed. The monitored signals may be signals transmitted via a wired communication channel connecting the UI board and the controller. The monitored signals, when being transmitted by the UI board, may be signals indicating user commands provided via a user interface comprised in the UI board.

In some exemplary embodiments, the signals being monitored may be signals transmitted by an Infrared (IR) receiver comprised in the user interface and configured for transmitting via the wired communication channel a signal to the controller in response to receiving an IR signal indicating a user command provided via an IR based remote control. Additionally or alternatively, the monitored signals may be signals emitted in response to a user engaging a button comprised in the user interface. The monitored signals may thus be signals indicating a user command, such as change state of A/C to a desired state, increase fan speed, change target temperature, or the like.

In some exemplary embodiments, the monitored signals may comprise output signals transmitted by the controller to the UI board and defining an output to be provided to a user of the A/C unit via an output device coupled to the UI board, the output being indicative of a state of the A/C unit. In some further exemplary embodiments, the output device may be a display device for displaying a state of the A/C unit. The monitoring module may be configured to monitor signals transmitted by the controller to the UI board for setting the display on the display device.

On Step 205, a state of the A/C unit may be automatically determined based on the monitored signals. In some exemplary embodiments, the state may be determined based on signals transmitted to the controller. In some further exemplary embodiments, the state may be automatically determined based on signals transmitted from the controller to the UI board, either in addition to or in lieu of signals transmitted to the controller.

In some exemplary embodiments, the automatic determination may be performed by a local device physically connected to the A/C unit and being responsible for performing the monitoring of Step 200, such as A/C Retrofitting Module 130 of FIG. 1B. In some further exemplary embodiments, the automatic determination may be performed partially or entirely by a remote server receiving indications on monitored signals from the local device.

Referring now to FIG. 2B, showing a flowchart diagram of a method, in accordance with some embodiments of the disclosed subject matter.

On Step 202, an input signal transmitted from the UI board to the controller may be received. The input signal may be received and potentially intercepted by a Man In the Middle (MITM) device, such as A/C Retrofitting Module 130 of FIG. 1B. The MITM device may allow the signal to be transmitted to the controller, such as by not blocking the signal, by retransmitting the signal after its interception, or the like. In some exemplary embodiments, the MITM device may transmit the signal to a remote server, such as via the Internet, for analysis.

On Step 204, an output signal transmitted from the controller to the UI board in response to the controller processing the input signal received on Step 202, may be received. Step 204 may be performed by the same or similar device to the device performing Step 202.

On Step 206, a state of the A/C unit may be automatically determined based on the output signal. The determination may be performed by the MITM device, by the remote server, or the like.

On Step 208, a mapping between input signals and target states of the A/C unit may be updated. The update may comprise adding to the mapping a mapping between the input signal received on Step 202 and the state determined on Step 206.

Referring now to FIG. 2C, showing a flowchart diagram of a method, in accordance with some embodiments of the disclosed subject matter.

On Step 210, a command may be received via a communication channel, such as, for example, the Internet. The command may indicate a desired target state of the A/C unit. Additionally or alternatively, the command may indicate a desired output to be provided to a user of the A/C unit. The command may be received by a MITM device, such as A/C Retrofitting Module 130 of FIG. 1B.

On Step 215, one or more signals each of which mimicking a signal transmitted between the UI board and the controller may be generated in response to the command received on Step 210. The generated signals may comprise a signal mimicking an input signal transmitted from the UI board to the controller, so as to cause the controller to switch the A/C unit to a target state indicated in the command. The generated signals may further comprise a signal mimicking an output signal transmitted from the controller to the UI board, so as to cause an output device coupled to the UI board to provide to a user an output indicated in the command. In some exemplary embodiments, the mimicking signals may be generated and transmitted by a MITM device, such as A/C Retrofitting Module 130 of FIG. 1B.

Referring now to FIG. 2D, showing a flowchart diagram of a method, in accordance with some embodiments of the disclosed subject matter.

On Step 200, signals transmitted between the UI board and the controller may be monitored, similarly as in FIG. 2A.

On Step 203, a predetermined pattern of user commands, indicated in signals transmitted from the UI board as monitored on Step 200, may be detected. The detection may be performed by the device monitoring the signals (e.g., MITM device such as A/C Retrofitting Module 130 of FIG. 1B), or by a device receiving indications of the monitored signals (e.g., a remote server connected via the Internet to the MITM device).

On Step 207, an enhanced functionality command corresponding to the predetermined pattern detected on Step 203, may be executed. The enhanced functionality command may be a command not supported by the controller. In some exemplary embodiments, execution of the enhanced functionality command may be effected through processing by a local device physically connected to the A/C unit (e.g., the MITM device). Additionally or alternatively, the enhanced functionality command or portion thereof may be processed by a separate computing device, such as a remote server or the like, being in communication with the local device via a communication channel, such as the Internet.

Referring now to FIG. 2E, showing a flowchart diagram of a method, in accordance with some embodiments of the disclosed subject matter.

On Step 200, signals transmitted between the UI board and the controller may be monitored, similarly as in FIGS. 2A and 2D.

On Step 209, signals transmitted from the UI board to the controller as monitored on Step 200 may be selectively blocked, whereby user commands may be selectively blocked. In some exemplary embodiments, the determination which signal to block may be performed by the local device (e.g., the MITM device). Additionally or alternatively, the determination may be performed by a remote server in communication with the local device, which may instruct the local device to block the signal. In some exemplary embodiments, the signal may be intercepted by the local device and upon a determination not to block the signal, the signal may be retransmitted to the controller by the local device.

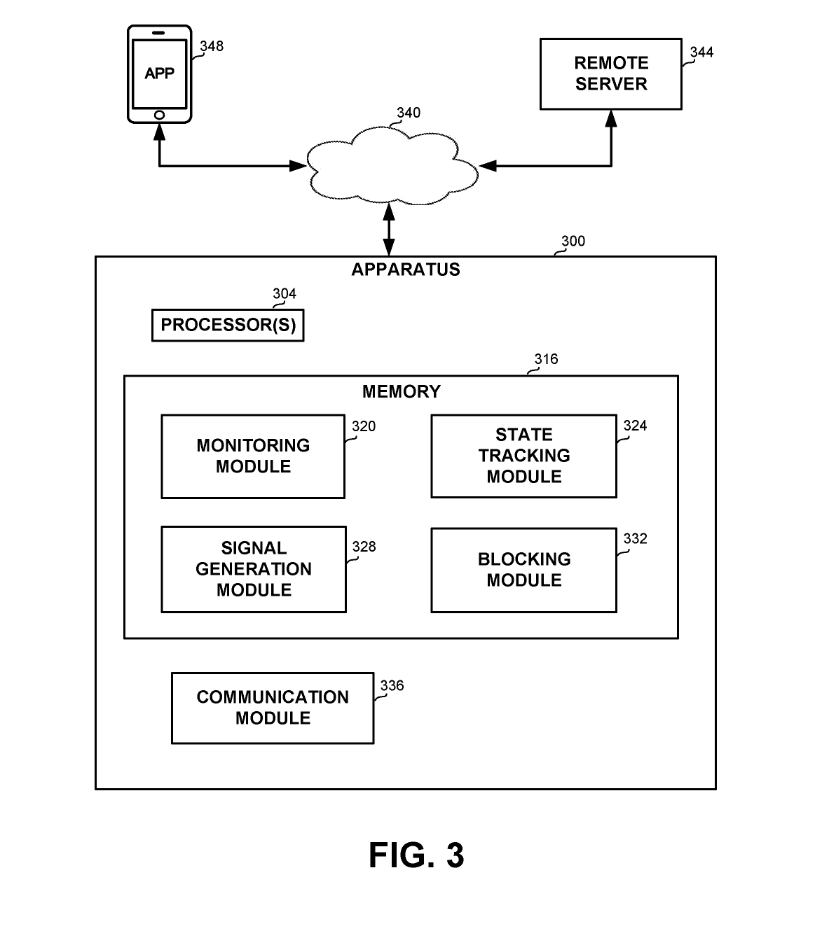

Referring now to FIG. 3, showing a block diagram of an apparatus, in accordance with some exemplary embodiments of the disclosed subject matter. An Apparatus 300, such as A/C Retrofitting Module 130 of FIG. 1B, may be configured for retrofitting an air conditioner (A/C) unit to computerized control, in accordance with the disclosed subject matter.

Apparatus 300 may comprise one or more Processor(s) 304. Processor 304 may be a Central Processing Unit (CPU), a microprocessor, an electronic circuit, an Integrated Circuit (IC) or the like. Processor 304 may be utilized to perform computations required by Apparatus 300 or any of it subcomponents.

In some exemplary embodiments, Apparatus 300 may comprise a Memory 316. Memory 316 may be a hard disk drive, a Flash disk, a Random Access Memory (RAM), a memory chip, or the like. In some exemplary embodiments, Memory 316 may retain program code operative to cause the Processor 304 to perform acts associated with any of the subcomponents of Apparatus 300. The components detailed below may be implemented as one or more sets of interrelated computer instructions, executed for example by Processor 304 or by another processor.

Monitoring Module 320 may be configured for monitoring signals transmitted between a UI board and a controller of an A/C unit via a wired communication line, similarly as in Step 200 of FIGS. 2A, 2D and 2E. Monitoring Module 320 may receive input signals transmitted from the UI board to the controller and indicating user commands, similarly as in Step 202 of FIG. 2B. Monitoring Module 320 may also receive output signals transmitted from the controller to the UI board and indicating an output to be provided to a user, similarly as in Step 204 of FIG. 2B. In some exemplary embodiments, Monitoring Module 320 may be further configured to monitor for and detect in the transmitted signals a predetermined pattern of user commands which corresponds to an enhanced functionality command, similarly as in Step 203 of FIG. 2D.

State Tracking Module 324 may be configured for automatically determining a state of the A/C unit based on signals monitored by Monitoring Module 320, similarly as in Step 205 of FIG. 2A. State Tracking Module 324 may dynamically track the state of the A/C unit based on user commands indicated in the signals monitored by Monitoring Module 320. State Tracking Module 324 may set and record an initial state of the A/C unit, and in response to a user command indicated in a transmitted signal monitored by Monitoring Module 320, State Tracking Module 324 may update the recorded state accordingly to reflect a target state effected by execution of the user command. Additionally or alternatively, State Tracking Module 324 may update the recorded state based on an output indicated by an output signal received by Monitoring Module 320, which output is intended to be provided to a user of the A/C unit to indicate its state.

In some exemplary embodiments, State Tracking Module 324 may be configured for automatically determining a state of the A/C unit based on an output signal transmitted by the controller to the UI board in response to received input signal, as monitored by Monitoring Module 320, similarly as in Step 206 of FIG. 2B. In some further exemplary embodiments, State Tracking Module 324 may be further configured for updating a mapping between input signals and target states of the A/C unit based on the determination, similarly as in Step 208 of FIG. 2B.

Signal Generation Module 328 may be configured for generating signals mimicking signals being transmitted between the UI board and the controller. Signal Generation Module 328 may generate one or more signals mimicking input signals transmitted from the UI board to the controller and indicating users commands, whereby causing the controller to switch to a desired target state. Signal Generation Module 328 may further generate one or more signals mimicking output signals transmitted from the controller to the UI board and indicating an output indicative of the state of the A/C unit to be provided to a user via an output device thereof.

In some exemplary embodiments, Signal Generation Module 328 may generate the signals in response to receiving a command to the A/C unit via a Communication Module 336 comprised by Apparatus 300 and being configured to send and receive data over a Communication Channel 340. Signal Generation Module 328 may receive the command and generate the corresponding one or more signals to fulfil it, similarly as in Steps 210 and 215 of FIG. 2C, respectively. Additionally or alternatively, Signal Generation Module 328 may generate the signals in response to detection of a predetermined pattern of user commands by Monitoring Module 320, wherein the signals being adapted to effect execution of the enhanced functionality command encoded by the pattern, similarly as in Step 207 of FIG. 2D.

Blocking Module 332 may be configured to block signals transmitted between the UI board and the controller, whereby causing user commands to be ignored by the A/C unit, and/or to prevent output from being provided to a user. Blocking Module 332 may apply the blocking selectively to particular signals monitored by Monitoring Module 320, similarly as in Step 209 of FIG. 2E.

In some exemplary embodiments, Apparatus 300 may be in direct or indirect communication with a Remote Server 344 and/or an Application Program (App) 348 executed by a computing device of a user. Apparatus 300 may communicate with Remote Server 344 and/or App 348 over any Communication Channel 340, such as, for example, the Internet. Remote Server 344 and App 348 may be configured to receive, process and/or store data sent from Apparatus 300 on the signals monitored by Monitoring Module 320. In some exemplary embodiments, State Tracking Module 324 may reside in whole or in part on Remote Server 344 and/or the computing device executing App 348, and receive data on monitored signals from Monitoring Module 320 via Communication Module 332.

Remote Server 344 and/or App 348 may be configured to transmit commands to Apparatus 300. In some exemplary embodiments, App 348 may communicate with Apparatus 300 via Remote Server 344. The commands may comprise instructions to Signal Generation Module 328 to generate signals mimicking input or output signals transmitted between the UI board and the controller of the A/C unit, and/or instructions to Blocking Module 332 to selectively block signals transmitted from the UI board to the controller or vice versa. In some exemplary embodiments, the instructions may be configured to effect execution of user commands provided using App 348.

In some exemplary embodiments, the signals monitored by Monitoring Module 320 may comprise error codes transmitted by the controller to the UI board to indicate an error state or malfunction of the A/C unit. Remote Server 344 may be configured to receive the error codes and utilize them for various purposes, such as, for example, product quality control, pre-emptive maintenance, automatic troubleshooting, data analytics, or the like.

For the ease of explanation, the above was depicted with respect to an air controller unit. However, the disclosed subject matter is not limited to such an embodiment. The disclosed subject matter may be applied on any appliance or electrical device having a separated UI board and controller, so as to allow for an integration of a MITM device in between such components.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus configured to be connected to an air conditioner,
wherein the air conditioner comprising a user interface (UI) board and a controller, wherein the UI board comprising a user interface for providing user commands, wherein the UI board and the controller are connected to one another via a wired communication channel, wherein a component of the air conditioner is configured to transmit signals to another component of the air conditioner via the wired communication channel;
wherein said apparatus being connected to the wired communication channel in between the UI Board and the controller;
wherein said apparatus comprising a monitoring module configured to monitor signals transmitted from the component of the air conditioner to the other component of the air conditioner, whereby content of the signal is extractable by the apparatus.

2. The apparatus of claim 1, the UI board is configured to transmit signals to the controller indicating the user commands; whereby user commands transmitted to the air conditioner are monitored by the monitoring module.

3. The apparatus of claim 2, wherein the content of the signals transmitted to the controller is indicative of a state of the air conditioner, whereby the state of the air conditioner is trackable based on the monitoring by said monitoring module.

4. The apparatus of claim 3, wherein said apparatus comprising a state tracking module configured to track the state of the air conditioner based on signals monitored by said monitoring module.

5. The apparatus of claim 2, wherein the user interface comprises an Infrared (IR) receiver, wherein a signal emitted from the IR receiver in response to said IR receiver receiving an IR signal, is transmitted via the wired communication channel to the controller, wherein said monitoring module is configured to monitor signals transmitted from the IR receiver, whereby said monitoring module monitors user commands provided via an IR based remote control.

6. The apparatus of claim 2, wherein the user interface comprises a button, wherein a signal emitted in response to a user pressing the button is transmitted via the wired communication channel to the controller, wherein said monitoring module is configured to monitor signals emitted in response to the button being pressed, whereby said monitoring module monitors user commands provided with the button.

7. The apparatus of claim 2,
wherein said monitoring module is configured to monitor for a predetermined pattern of user commands;
wherein said apparatus is configured, in response to said monitoring module detecting the predetermined pattern of commands, to execute an enhanced functionality command, wherein the enhanced functionality command corresponds to the predetermined pattern of user commands, whereby extending the user interface provided by the air conditioner to include commands not supported by the controller.

8. The apparatus of claim 1, wherein the UI board is coupled to an output device for providing output to a user of the air conditioner, wherein the controller is configured to transmit, via the wired communication channel, to the UI board signals defining an output to be provided via the output device, wherein the monitored signals comprise output signals indicative of a state of the air conditioner.

9. The apparatus of claim 8, wherein the output device is a display device for displaying a state of the air conditioner, wherein the controller is configured to set a display on the display device by transmitting signals to the UI board, wherein said monitoring module is configured to monitor signals setting the display on the display device.

10. The apparatus of claim 8, wherein the controller is configured to send error codes to be displayed via the display device, wherein said monitoring module is configured to monitor error codes transmitted to the display device, whereby an error state of the air conditioner is trackable.

11. The apparatus of claim 1, wherein said monitoring module is configured to monitor input signals transmitted to the controller and output signals transmitted from the controller, wherein based on the input and output signals, said apparatus dynamically determining a mapping between input signals and target states of the air conditioner set by the controller.

12. The apparatus of claim 1 further comprising a communication module for receiving and transmitting data via a communication network, wherein said monitoring module is coupled via said communication module with a remote server, whereby the remote server is enabled to process the monitored signals.

13. The apparatus of claim 1 further comprising a signal generation module for generating signals to the controller mimicking signals generated by a component of the air conditioner.

14. The apparatus of claim 13, wherein said signal generation module is configured to generate a signal mimicking a signal generated by the UI board and transmit the generated signal to the controller, whereby simulating user input via the UI board.

15. The apparatus of claim 14, wherein said signal generation module is configured to generate a signal in response to receiving a command via a communication network.

16. The apparatus of claim 15, wherein said signal generation module is coupled via said communication module with an application program executed by a computing device of a user, wherein said signal generation module is configured to generate signals in response to user commands in the application program.

17. The apparatus of claim 1 further comprising a blocking module for selectively blocking input signals from the component of the air conditioner to the other component of the air conditioner.

18. An apparatus configured to be connected to an air conditioner,
wherein the air conditioner comprising a user interface (UI) board and a controller, wherein the UI board comprising a user interface for providing user commands, wherein the UI board and the controller are connected to one another via a wired communication channel, wherein the UI board is configured to transmit signals to the controller indicating the user commands;
wherein said apparatus being connected to the wired communication channel in between the UI Board and the controller;
wherein said apparatus comprising a signal generation module for generating signals to a component of the air conditioner mimicking signals generated by another component of the air conditioner.

19. The apparatus of claim 18, wherein said signal generation module is configured to generate signals mimicking signals generated by the UI board, wherein said signal generation module is configured to generate a signal to be provided to the controller in response to receiving a command via a communication module comprised by the apparatus, whereby controlling the air conditioner based on a remote command from a source external to the air conditioner without using the user interface of the air conditioner.

20. The apparatus of claim 18, wherein said signal generation module is configured to generate signals mimicking signals generated by the controller, wherein said signal generation module is configured to generate a signal to be provided to the UI board, whereby utilizing an existing output mechanism of the air conditioner to provide output to a user of the air conditioner.

21. A method comprising:
monitoring signals transmitted from a component of an air conditioner to another component of the air conditioner, wherein the air conditioner comprises components that comprise a user interface (UI) board and a controller, wherein the UI board comprising a user interface for providing user commands, wherein the UI board and the controller are connected to one another via a wired communication channel, wherein said monitoring is performed using a Man In The Middle (MITM) device physically connected to the wired communication channel in between the component and the other component.

22. The method of claim 21 further comprises automatically determining, based on monitored signals transmitted to the controller, a state of the air conditioner.

23. The method of claim 21, wherein the UI board comprising an output device for providing output to a user of the air conditioner, wherein signals transmitted by the controller to the UI board define an output to be provided via the output device, wherein said method further comprises:
analyzing the monitored signals to detect an error message transmitted from the controller to the UI board; and
performing an action in response to detecting the error message.

24. The method of claim 21, further comprising generating, responsive to a command received via a communication network, an input signal to be provided to the controller and mimicking a signal generated by the UI board, whereby controlling the air conditioner based on a remote command from a source external to the air conditioner without using the user interface of the air conditioner.

25. The method of claim 21, wherein the UI board comprising an output device for providing output to a user of the air conditioner, wherein signals transmitted by the controller to the UI board define an output to be provided via the output device, wherein said method further comprises generating an output signal to be provided to the UI board and mimicking a signal generated by the controller, whereby extending an existing output mechanism of the air conditioner to provide additional output to the user.

26. The method of claim 21, further comprising selectively blocking signals transmitted from the component to the other component, whereby selectively ignoring user commands or output messages.

27. The method of claim 21, wherein the UI board comprising an output device for providing output to a user of the air conditioner, wherein signals transmitted by the UI board to the controller are indicative of user commands provided via the UI board, wherein signals transmitted by the controller to the UI board define an output to be provided via the output device, wherein the output is indicative of a state of the air conditioner; said method further comprises:
receiving an input signal transmitted from the UI board to the controller;
receiving an output signal transmitted from the controller to the UI board in response to the controller processing the input signal;
determining a state of the air conditioner based on the output signal; and
updating a mapping between input signals and target states of the air conditioner set in response to the input signals, wherein said updating comprises adding a mapping between the input signal and the state of the air conditioner.

28. The method of claim 21, wherein said monitoring comprises monitoring for a predetermined pattern of user commands defining an enhanced functionality command not supported by the controller and extending the user interface of the air conditioner, and in response to detecting the predetermined pattern of user commands, executing the enhanced functionality command.
